(19) United States
(12) Patent Application Publication
(10) Pub. No.: US 2002/0091876 A1
(43) Pub. Date: Jul. 11, 2002

(54) Input/output operating device

(75) Inventor: Hong Kin-Tse, Taipei (TW)

Correspondence Address: DOUGHERTY & TROXELL, SUITE 1404, 5205 LEESBURG PIKE, FALLS CHURCH, VA, 22041, US

(73) Assignee: PORTWELL INC.

(21) Appl. No.: 09/754,364

(22) Filed: Jan. 5, 2001

(51) Int. Cl. G06F 3/00

(52) U.S. Cl. 710/1

(57) ABSTRACT

The present invention relates to an input/output operating device being installed onto the panel of a computer system, and such panel having a display element and at least one output element, and a converting interface being disposed at the rear side of the panel. The converting interface connects to a display element and input element via circuits, and the converting interface has a compatible connecting port that can be connected to the display element, input element, and the communication interface such as I²C and RS-232, etc., so that it connects to the computer system. The user can operate the input element and display element operating directly through the panel and needs not to use externally connected operating element and monitor. It is applicable to any computer system that has such communication interface, and save the hardware development cost. Furthermore, the user can use the application interface (API) of the operating system and needs not to develop individual driver for different operating systems in order to save the software development cost.

### BACKGROUND OF THE INVENTION

1. Field of the Invention

The present invention relates to an improved input/output operating device being installed to a panel of a computer system, more particularly to an improved input/output operating device being installed to a panel of a computer system, and such panel connects to the display element and input element which are connected to a computer system through a converting interface.

2. Description of the Related Art

General computer system has a structure of an opened shell, and such opened shell has a main board which has a power supply, and a plurality of slots. Such slots have different functional cards individually inserted into each of them for the connection with the main system, and the main board has a plurality of ports so that the user can control the display by the keyboard, the monitor on remote end by the parallel cable, and the instructions through the keyboard. However, the user controls the computer operations from a remote end, and is unable to directly perform the operations on the main system. It is very troublesome for the control of being unable to timely give correct instructions at the time of the occurred situation.

In order to overcome the foregoing shortcomings, the keyboard and monitor are connected to the main system through the port, and the user can control the occurring situation directly. However, the application service provided by the computer usually is configured, therefore there are not too many instructions to be input. It does not need that many keys as used in a regular keyboard of a personal computer, therefore a simplified keyboard for personal computer shows up in the market. The arrangement of a simplified keyboard may reduce the volume of the entire keyboard, but the computer casing has to reserve the space for its installation anyway, and it is definitely a waste of spaces.

To further improve the foregoing shortcomings, some designers place the control buttons and the indicating lights on the panel of the computer to save spaces. Each of the control buttons and indicating lights has to be connected to a circuit line and to the computer system one by one to their corresponding positions. Such arrangement allows the connection to the computer, but it is very complicated and troublesome, and it is easy to have wrong connections, and even worse, the computer system needs to preload the designated driver to connect the computer system with the control buttons and the monitor.

The inventor of the present invention observed the foregoing shortcomings and started to make improvement according to the crucial reasons and search for a reasonable resolution. After many times of research analyses and designs, the inventor finally designs a computer panel that can be installed onto the computer system, and such panel has a display element and at least one output element, and a converting interface being disposed at the rear side of the panel. The converting interface connects to a display element and input element via a circuit, and the converting interface has a compatible connecting port that can be connected to the display element, input element, and the communication interface such as I²C and RS-232, etc.

### SUMMARY OF THE INVENTION

The objective of this invention is by the foregoing device for the installation to connect the port of the computer via the converting interface so that it can connect the display element and input element of the computer system with simple installation.

Another objective of the present invention is to install the control devices onto the panel of the computer system and connect to the port of the computer system via the converting interface so that the user can directly configure or operate the computer system via the input element and display element of the control device. It no longer needs the input device and monitor that are connected externally in order to save room and have a more convenient way of operation.

To make it easier for our examiner to understand the objective of the invention, its structure, innovative features, and its performance, we use a preferred embodiment together with the attached drawings for the detailed description of the invention.

### BRIEF DESCRIPTION OF THE DRAWINGS

Other objects, features, and advantages of the invention will become apparent from the following detailed description of the preferred but non-limiting embodiment. The description is made with reference to the accompanying drawings, in which:

FIG. 1 shows an illustrative block diagram of a preferred embodiment of the present invention.

FIG. 2 shows a three-dimensional diagram of the disassembled parts of the present invention.

FIG. 3 shows an illustrative diagram of the present invention when it is in use.

### DETAILED DESCRIPTION OF THE PREFERRED EMBODIMENT

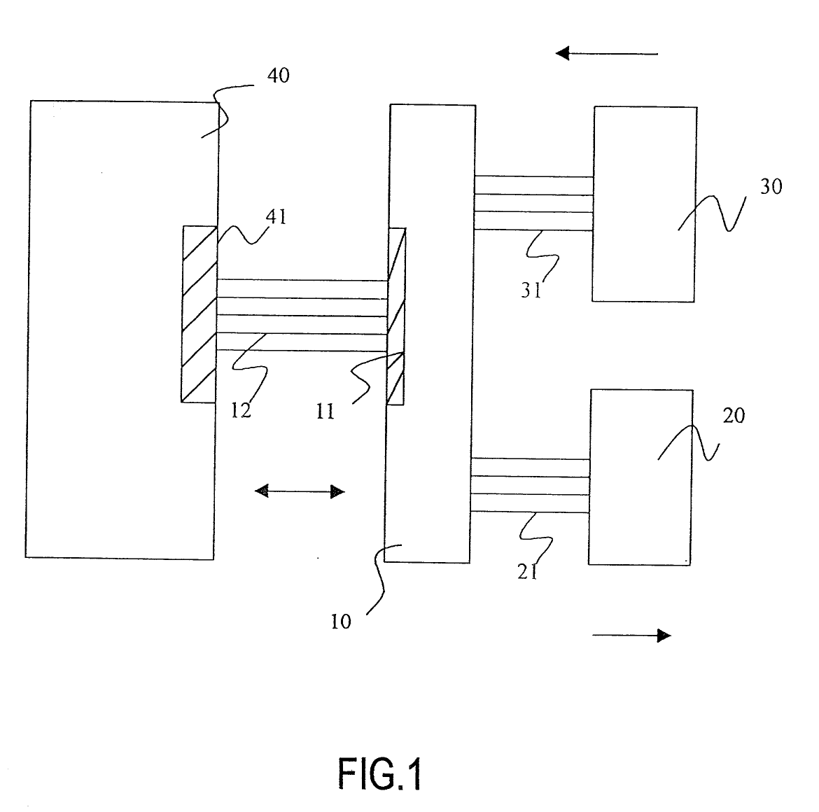

Referring to FIG. 1. The present invention relates to an improved input/output operating device, and such input/output operating device is one being installed to a computer system. A converting interface 10 is used for such operation and the converting interface for this embodiment is a micro-controller (serial number 16C54), and the converting interface 10 separately connect to a display element 20 and at lease one input element 30. A port 11 compatible to a communication interface is disposed on the converting interface 10, and such port 11 connects to the communication interface port 41 of the computer system 40 via a parallel cable 12 so that the user can press any or many keys via the input element 30, such signal is converted into a signal which can be received by a standard communication interface (such as I²C, RS-232, etc.) and is directly sent to the computer system 40 via the communication interface port 41 of the computer system 40. The computer system 40 will then display the desired string or execute the instruction via the standard communication interface port 41 and transmitted to the converting interface 10. The converting interface 10 will convert this string or instruction into a signal which can be received by the display element 20, and let the display element execute (such as displaying a string, or executing a clear screen, etc.) Such arrangement is much simpler and more convenient than the prior art which has to connect all of the circuits 21, 31 of the display element 20 and the input element 30 directly on the computer system 40, and does not need software driver preloaded into the computer system 40 to comply with the display element 20 and input element 30. The user just needs to run the driver software, which is very simple in application.

As mentioned above, the present invention does not just apply to any computer system that has such communication interface in order to save hardware development cost, it also can use the application interface (API) of the operating system, and does not needs to develop individual driver for different operating system (OS) to save development cost.

The foregoing display element 20 and input element 30 are display screen and touch key respectively. However the person skilled in the art can replace them with other elements.

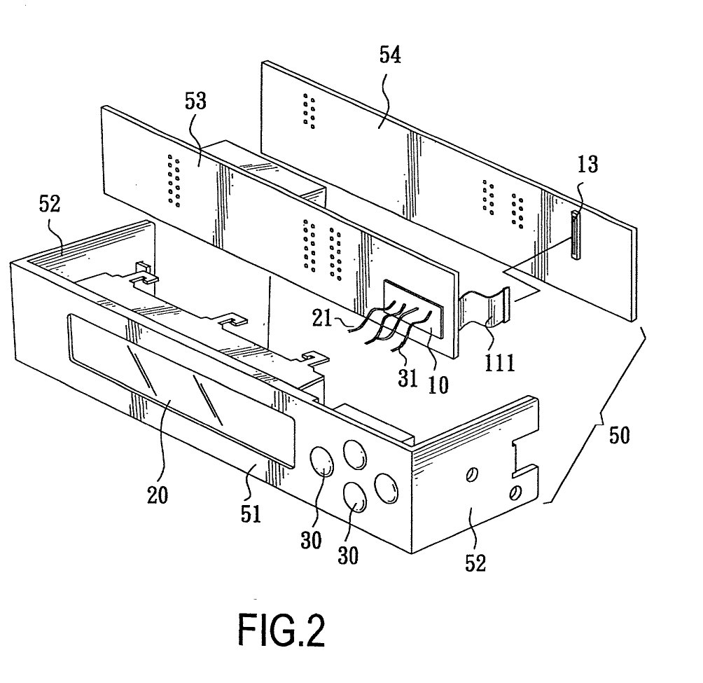

To let the examiner further understand the present invention, the input/output operating device according to the present invention is installed onto a panel 50. Referring to FIG. 2, the panel 50 has a frame 51 that is for installing the display element 20 and at least one input element 30. Each of the lateral sides of the frame 51 has a side panel 52 that is bent in the same direction and vertical to the frame 51. A ply board 53 is disposed at the rear side of the panel 51 and fits exactly in the gap between the two side boards 52. The ply board 53 is used for installing the converting interface 10, and the converting interface 10 connects to the display element 20 and the input element 30 on the frame 51 via the circuits 21, 31. The port 11 of the converting interface 10 (as shown in FIG. 1) connects to a parallel cable 111, and the other end of the parallel cable 111 connects to the socket 13 of a communication interface. The socket 13 is fixed to a rear panel 54 coupled to the frame 51.

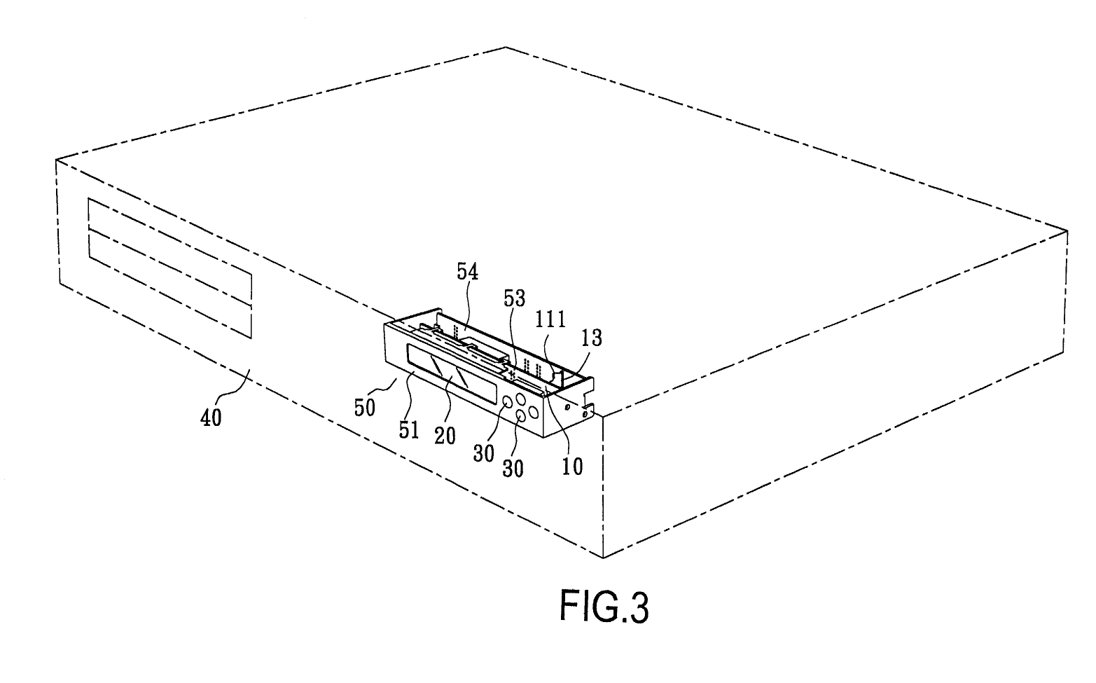

Referring to FIG. 3. When the panel 50 is installed onto the computer system 40, and the socket 13 is installed at the communication interface port 41 of the computer system 40 (Please refer to FIG. 1). It does not just simplify the circuit connected between the display element 20 and the input element 30 on the panel 50 and the computer system 10 by the converting interface 10, and it also allows users to press any key of the input element 30 so that the converting interface 10 converts the signal into one that can be received by the standard communication interface (such as the I²C, RS-232, etc.) and then transmits the signal to the computer system 40. The computer system 40 converts the desired string or instruction into a signal that can be received by the display element 20 via the converting interface 10, and let the display element 20 to carry out the instruction (such as the display of the string or execute the clear screen instruction, etc.) The computer system 40 no long needs other circuit or software to connect with the display element 20 and the input element 30. It facilitates a simple and convenient operation.

In summation of the above description, the present invention incorporates a simple structure, which enhances the performance of the conventional structure and further complies with the patent application requirements. Hence, the invention is submitted to the Patent and Trademark Office for review and granting of the commensurate patent rights.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. An improved input/output operating device, comprising:
a panel, having a display element and at least one output element;
a converting interface, being disposed on the panel, and said converting interface being connected to a display element and an input element of the panel by a circuit, and having a port compatible to standard communication interface; whereby the foregoing structure allows the connection to the computer system by connecting the display element and input element to the port of compatible standard communication interface via the converting interface.

2. An improved input/output operating device as claimed in claim 1, wherein said display element is a display screen.

3. An improved input/output operating device as claimed in claim 1, wherein said input element is a touch key.

4. An improved input/output operating device as claimed in claim 1, wherein said communication interface is a RS-232 interface.

5. An improved input/output operating device as claimed in claim 1, wherein said communication interface is an I²C interface.
